(19) United States
(12) Patent Application Publication
(10) Pub. No.: US 2002/0057465 A1
(43) Pub. Date: May 16, 2002

(54) Image input apparatus

(75) Inventor: Toshiaki Anzai, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki (JP)

(21) Appl. No.: 09/758,432

(22) Filed: Jan. 12, 2001

(30) Foreign Application Priority Data
May 31, 2000 (JP) 2000-162604

(51) Int. Cl. H04N 1/04

(52) U.S. Cl. 358/474

(57) ABSTRACT

This image input apparatus comprises conveying mechanisms 12 to 15 for conveying a document in a sub-scanning direction; a photoelectric transfer unit 10 for reading the document to be conveyed; a flat bed 70 mounting the document; a screen 3 provided at a reading position of the photoelectric transfer unit 10; and movable optical units 2, 5 for sub-scanning the document on the flat bed 70 and projecting images of the document on the screen 3. The document on the flat bed is read by use of the photoelectric transfer unit of a fixed ADF, and the screen is provided at a reading position of the photoelectric transfer unit, and the images of the movable optical unit are projected on this screen. Thus, a connection cable of a read part of the flat bed is not required, and it is possible to restrict the occurrence of the EMI which may cause the trouble in other devices.

### BACKGROUND OF THE INVENTION

1. Field of the Invention

The present invention relates to an image input apparatus for optically reading an image of a document, and in particular to an image input apparatus having both an ADF function of reading a document while moving it, and a flat bed function of reading the fixed document.

2. Description of the Related Arts

As a peripheral unit of a computer or a printer, an image input apparatus which optically reads a two-dimensional image of a document is exploited. This image input apparatus has an ADF (Automatic Document Feeder) type of conveying a document while reading it and a flat bed type of reading the fixed document. Since the former automatically feeds the document, the former enables a high-speed image input, but cannot read the document as a sheet-like. On the other hand, the latter can read a document having any shape, but is required to set the document manually. For this reason, a combined image input apparatus comprising the both is provided.

FIG. 12 is an explanatory view of the prior art. As shown in FIG. 12, the combined image input apparatus has an ADF read part 101 and a flat bed 110. In the ADF reading, a document 200 mounted on a hopper 100 is passed through the ADF read part 101, and is ejected to a stacker 102. In the ADF read part 101, after the document 200 of the hopper 100 is fed out, it is conveyed by a feed roller 103, while reflected lights on a surface of the document 200 are detected and an image of the document 200 is acquired by a front surface optical unit 105. The optical unit 105 has an optical detection element (for example, CCD) 106 for detecting the reflected lights, and an optical system 107.

On the other hand, in the flat bed reading, a document is set to the flat bed 110. A front surface optical unit 111 moves the document fixed on the flat bed 110 in a sub-scanning direction by a stepping motor 112 and a belt 113, and reads the document. This optical unit 111 has an optical detection element (for example, CCD) 114 for detecting reflected lights of the document, and an optical system 115.

This optical unit 111 sets a position of a home position shown in FIG. 12, whereby when ADF-reading, the optical unit 111 can read a back surface of the conveying document 200. Namely, the optical unit 111 can both read the document of the flat bed 110 and read a back surface of the document of the ADF. For this reason, a both-face reading mechanism of the ADF is a simple structure.

However, first, in the prior art, a movable optical unit is fixed, then a back surface of a conveying document is read, and the movable optical unit is moved, and the document of the flat bed is read, whereby the structure is simplified. In this structure, the optical unit can be made serve a double purpose, however as the unit contains a photoelectric transfer element such as CCD or the like, the movable optical unit is connected to an electric circuit inside the device by an electrically connecting cable, and it is necessary that a long cable is provided to move. For this reason, radio waves are easy to emit from a cable, and there is caused a problem that a malfunction in the inside electric circuit, the outside computer, or the like occurs.

Second, in the prior art, the conveying document is read by the movable optical unit, but since the read position is limited to a position at an end part of the flat bed in the movable scope, a hopper, etc. is hard to install, and there arises a problem that it is difficult to annex the ADF (Automatic Document Feeder) function.

Third, in the prior art, it is necessary to provide two optical units in order to read both faces of the document, and there was a problem that this was a hindrance in a reduction in manufacturing costs.

### SUMMARY OF THE INVENTION

It is therefore an object of the present invention to provide an image input apparatus capable of ADF-reading and flat-bed-reading without providing a long cable.

It is another object of the present invention to provide the image input apparatus which realizes the ADF reading for automatically feeding papers from the hopper and the flat bed reading with a simple structure.

It is still another object of the present invention to provide the image input apparatus which realizes the ADF reading of both faces of the document and the flat bed reading with a simple structure.

In order to attain the above objects, according to a first aspect of the present invention there is provided an image input apparatus for optically reading a document and inputting images of the document, comprising a conveying mechanism for conveying the document in a sub-scanning direction; a photoelectric transfer unit for reading the document to be conveyed; a flat bed mounting the document; a screen provided at a reading position of the photoelectric transfer unit; and a movable optical unit for sub-scanning the document on the flat bed and projecting the images of the document on the screen.

According to the present invention, a photoelectric transfer unit of the fixed ADF is used, so that the document on the flat bed is read. For this reason, first, the flat bed is provided with a movable optical unit not having a photoelectric transfer element, and reading lights from this optical unit are led to the photoelectric transfer unit of the ADF. Second, since images from the optical unit are read by the photoelectric transfer unit, a screen is provided at a reading position of the photoelectric transfer unit, and the images of the movable optical unit are projected on this screen. Thus, a connection cable of a read part of the flat bed is unrequired, and it is possible to restrict the occurrence of radio waves.

In another form of the image input apparatus of the present invention, the screen is provided in the document conveying route of the conveying mechanism, thus making it possible to share the read position of photoelectric transfer unit, to achieve a simple structure and a reduced size.

The other form of image input apparatus of the present invention further comprises a hopper for mounting the document to be conveyed by the conveying mechanism; and a switching mirror for switching a reading position of the photoelectric transfer unit between the reading position of the conveying mechanism and the screen, thereby making is possible to dispose the hopper at a position not allowing the interference with the flat bed, thus achieving an easy implementation of the ADF function.

The image input apparatus of the present invention further comprises a second conveying mechanism for conveying the document to be read by the photoelectric transfer unit from an exit of the conveying mechanism to the flat bed is provided, and the screen is provided in the document conveying route of the second conveying mechanism, thereby enabling a single photoelectric transfer unit to implement the both side read and the flat bed read, thus achieving a remarkable reduction of the apparatus costs.

The image input apparatus of the present invention further comprises an ADF unit provided with the conveying unit and the photoelectric transfer unit; and a flat bed unit having the flat bed, the screen, and the movable optical unit, wherein the ADF unit is separable from the flat bed unit, whereby after the purchase of the ADF unit, the flat bed unit can be attached thereto, thus enabling the image input apparatus to be graded up in conformity with the mode of utilization.

### BRIEF DESCRIPTION OF THE DRAWINGS

FIG. 1 is a configuration diagram of an image input apparatus according to an embodiment of the present invention;

FIG. 2 is an operational explanatory view at the time of reading a front surface of FIG. 1;

FIG. 3 is an explanatory view of a control procedure at the time of reading the front surface of FIG. 1;

FIG. 4 is an operational explanatory view at the time of reading the back surface of FIG. 1;

FIG. 5 is an explanatory view of the control procedure at the time of reading the back surface of FIG. 1;

FIG. 6 is an operational explanatory view at the time of reading the flat bed of FIG. 1;

FIG. 7 is an explanatory view of the control procedure at the time of reading the flat bed of FIG. 1;

FIG. 8 is an operational explanatory view at the time of reading the transparent document of FIG. 1;

FIG. 9 is an explanatory view of the control procedure at the time of reading the transparent document of FIG. 1;

FIG. 10 is a configuration diagram according to a modification example of FIG. 1;

FIG. 11 is a configuration diagram according to another embodiment of the present invention; and

FIG. 12 is a configuration diagram of the prior art.

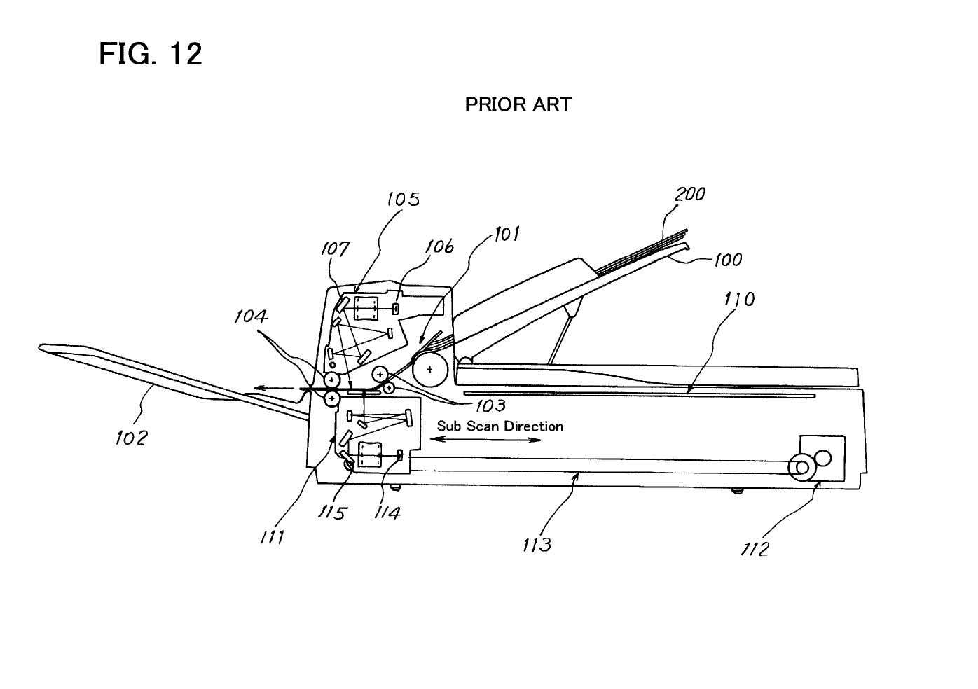

### DESCRIPTION OF THE PREFERRED EMBODIMENTS

The precharge embodiments of the present invention will now be described by sorting it into an image input apparatus, an image input operation, and the other embodiment.

### IMAGE INPUT APPARATUS

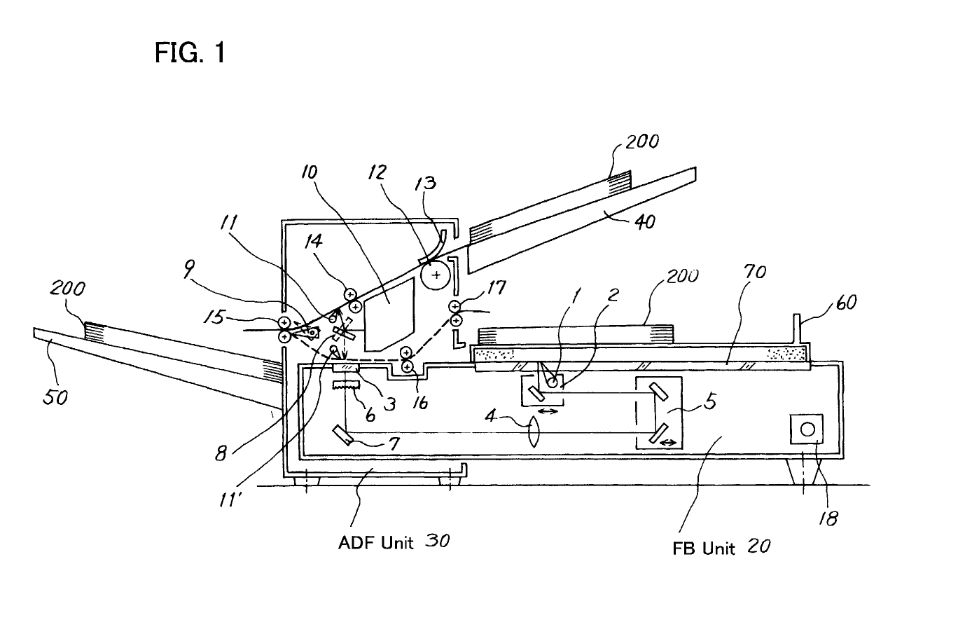

FIG. 1 is a configuration diagram of the image input apparatus according to an embodiment of the present invention. In this example, the image input apparatus having a both-face ADF function and a flat bed function is adopted as an example.

As shown in FIG. 1, the image input apparatus comprises an ADF (Automatic Document Feeder) unit 30, and a FB (Flat Bed) unit 20. The ADF unit 30 comprises a hopper 40, a CCD optical system 10, lamps 11, 11′, ADF mechanisms 12 to 17, a switching mirror 8, a switching valve 9, and a stacker 50.

On the hopper 40, a plurality of documents (slips) 200 to be read can be mounted. A press member 13 and a separation roller 12 separate the document 200 of the hopper 40 one by one. A conveying roller 14 conveys the separated document 200 to a reading position. An ejection roller 15 ejects the read document 200 to the stacker 50. A first conveying mechanism is constituted thereby. The lamp (fluorescent light) 11 irradiates one face (front surface) of the document 200 at the reading position of a first document conveying route.

A second conveying mechanism has a conveying roller 16 and an ejection roller 17. The document 200 is conveyed from the ejection roller 15 of the first conveying mechanism to a flat head 70 by the conveying rollers 16, 17. The lamp 11′ irradiates the other face (back face) of the document 200 at the reading position of a second document conveying route. Since the document from the first conveying route is led to the second conveying route, the switching valve 9 switches a conveying path.

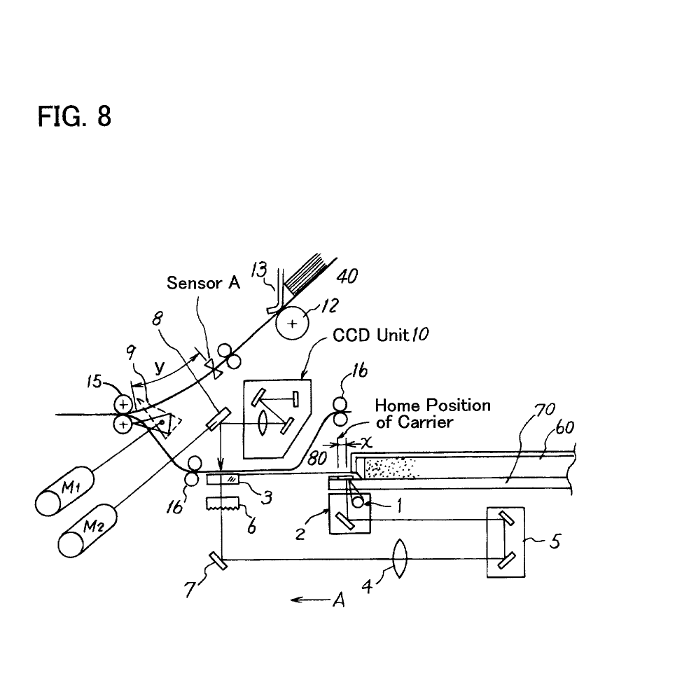

The CCD optical system (photoelectric transfer unit) 10 is provided between the first conveying route and second conveying route. The CCD optical unit 10 has a well known configuration, and the inside is as shown in FIG. 8, having a photoelectric transferor for transferring reflected lights to an electric signal, and a lens and a mirror for making a focus of an image at the reading position in conformity with the photoelectric transferor. The photoelectric transferor is constituted by a CCD (Charge Coupled Device). In order to switch a reading of the CCD optical unit 10, the switching mirror 8 switches an input of the reflected lights of the CCD optical system 10 into the reflected lights from a reading position of the first conveying route and the reflected lights from a reading position of the second conveying route.

Next, the FB unit 20 has a document table(document stand) 70 as a stand of a document, etc. The flat bed 70 is constituted by a transparent glass, etc. The FB unit 20 further has a movable document read part 2, a movable mirror 5, a fixed lens 4, a reflection mirror 7, a Fresnel lens 6, a screen 3, and a movable part move motor 18. 2 and 5 are called “carrier unit” also.

The movable read part 2 and movable mirror 5 are moved to the flat bed 70, namely a sub-scanning direction of the document, by the motor 18. The movable read part 2 has the lamp 1 for irradiating the flat bed 70, and the reflection mirror for leading the reflected lights to the movable mirror 5. The reading image of the document read part 2 is projected on the screen 3 via the movable mirror (intermediate mirror) 5, the lens 4, the reflection mirror 7, and the Fresnel lens 6.

According to movement of the document read part 2, the movable mirror 5 is moved so as not to misalign a focus of the image on the screen 3. The Fresnel lens 6 provided in front of the screen 3 is provided in order to correct a brightness at a center and left and right ends of the document. The screen 3 is provided facing the second conveying route of the ADF unit 30, for example is constituted by a frosted glass. This position is a focus position (reading spread face) of the CCD optical system 10, as described above.

The operation of this device is to be described below. This example denotes the both-face reading ADF mechanism, but may be one of a one-face reading.

### IMAGE INPUT OPERATION

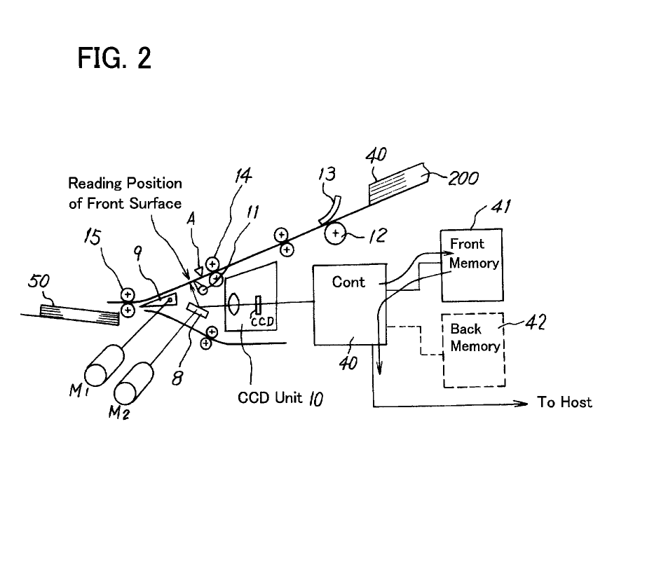

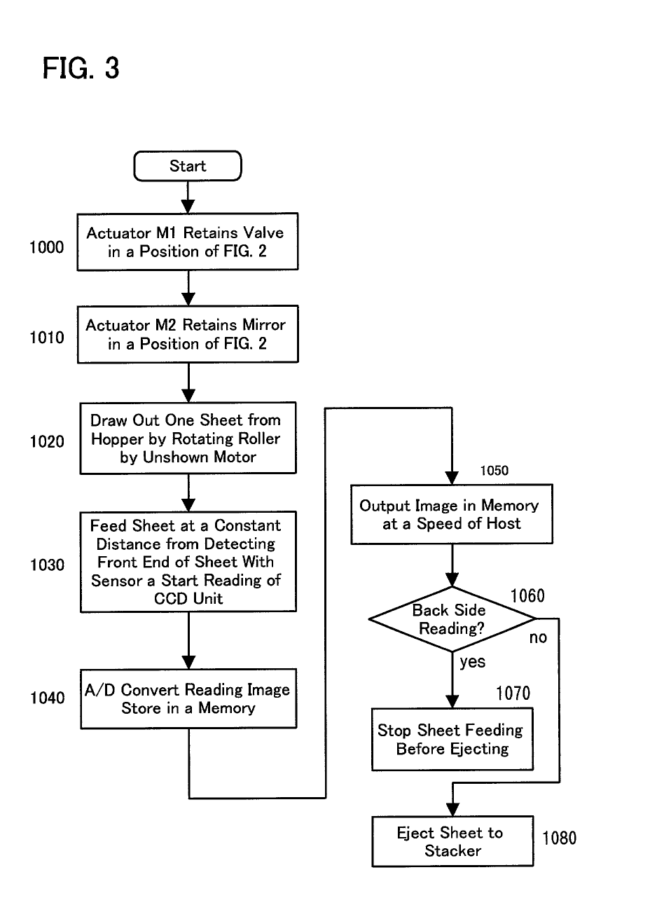

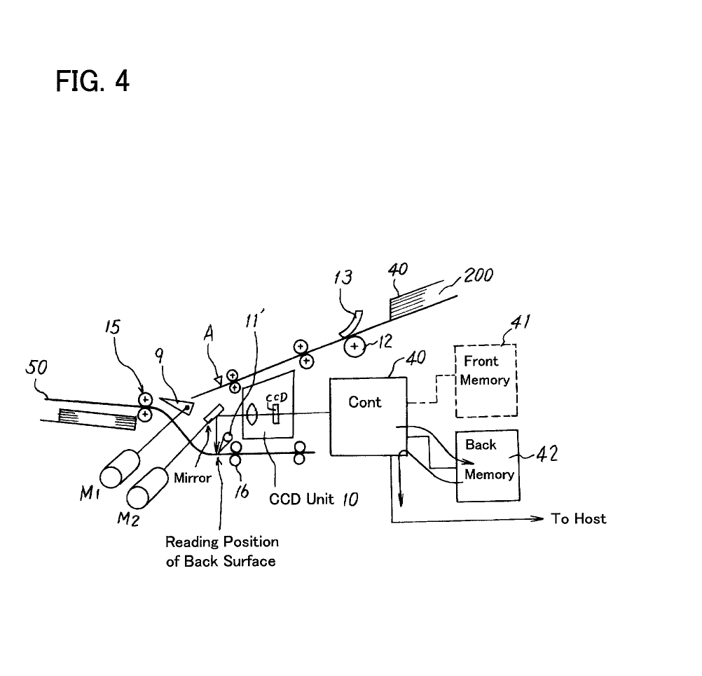

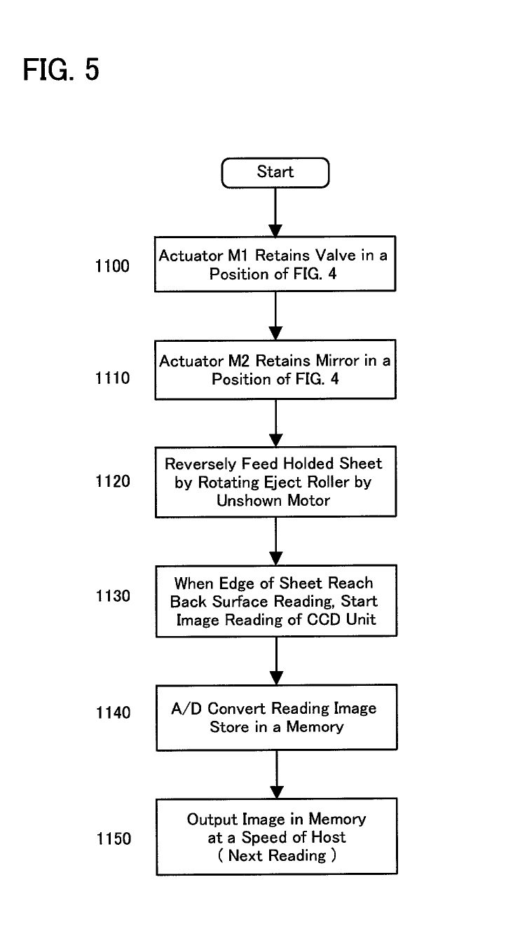

FIGS. 2 and 3 are explanatory views of ADF front surface reading. FIGS. 4 and 5 are explanatory views of ADF back face reading operation.

According to FIG. 3, with reference to FIG. 2, front surface reading operation will be explained. The valve 9 is retained at a position of FIG. 2 by an actuator M1 (1000). As shown in FIG. 2, the switching mirror 8 is retained at the surface reading position by an actuator M2 (1010) and the lamp 11 is lit. A separation roller 12 is drawn out by a motor (not shown), and a sheet (document) 200 is fed from the hopper 40 (1020). After a sheet front end is detected by a sensor A and is conveyed at a constant distance (a constant time elapses),an image reading of the CCD unit 10 is started (1030). The reading image of CCD unit 10 is analog-digital-converted by a controller 40, and is stored in a memory 41 for front surface (1040). After the front surface of the sheet is finished reading, the controller 40 outputs the image of the surface memory 41 in conformity to a speed of a host computer (1050). It is judged whether or not reading of a back face is specified (1060). In the case where the back face is read, the sheet is stopped conveying prior to an ejection of the sheet from the ejection roller 15, and a rear end of the sheet is gripped (1070). In the case where the back face is not read, the sheet is ejected to the stacker 50 (1080).

Next, according to FIG. 5, with reference to FIG. 4, back face reading operation will be explained. The valve 9 is retained at a position of FIG. 4 by the actuator M1 (1100). As shown in FIG. 4, the switching mirror 8 is retained at the back surface reading position by the actuator M2 and the lamp 11′ is lit (1110). The ejection roller 15 is rotated by a motor (not shown), and a sheet retained by the ejection roller 15 is fed in a reverse direction, and is led to the second conveying route via the valve 9 (1120). When the sheet front end reaches a back surface reading position, an image reading of the CCD unit 10 is started (1130). The reading image is analog-digital-converted by the controller 40, and is stored in a memory for a back surface 42 (1140). After the back surface of the sheet is finished reading, the controller 40 outputs the image of the back surface memory 42 in conformity to a speed of the host computer (1150). At this transfer, the controller 40 can execute the surface reading of the succeeding sheet. The read sheet is, as shown in FIG. 1, ejected onto a document cover 60 provided on the flat bed 70.

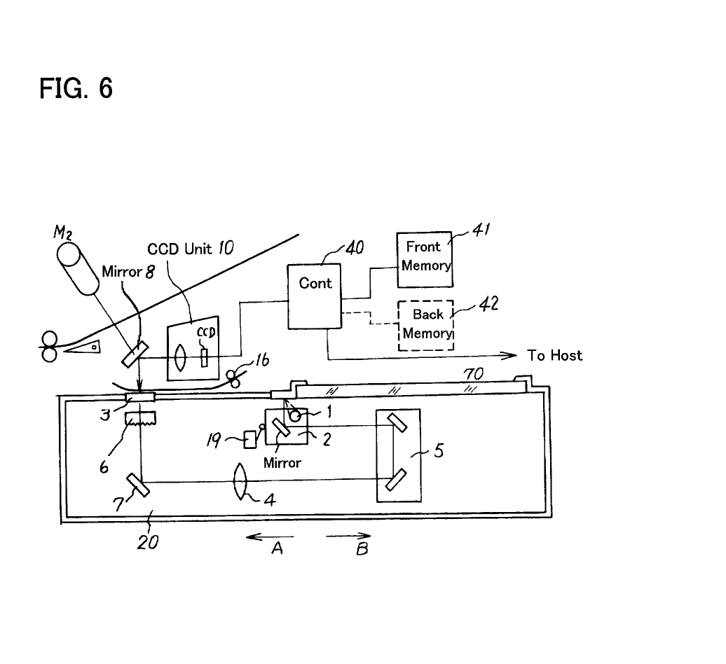

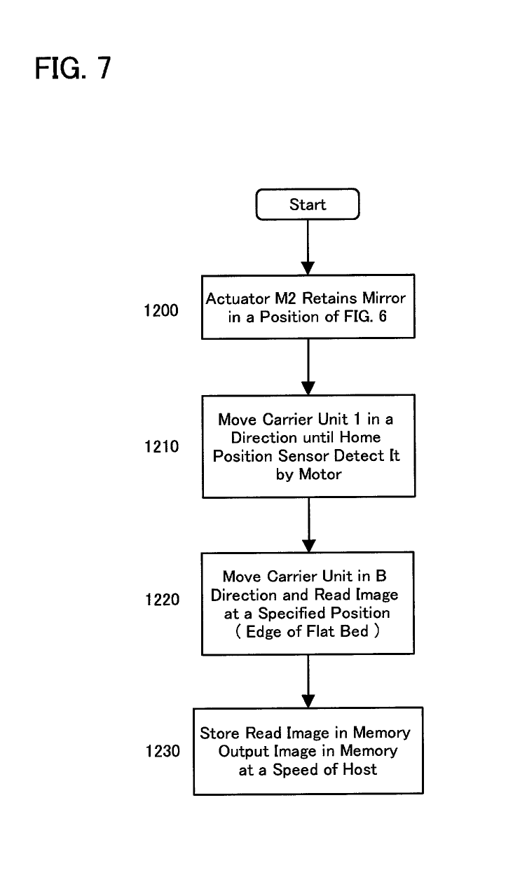

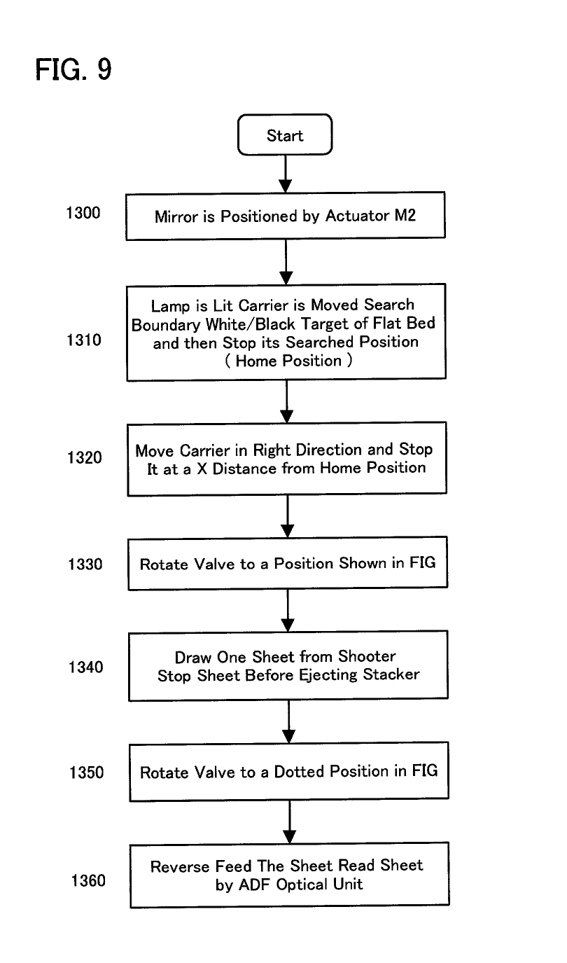

FIGS. 6 and 7 are explanatory views of operation of the flat bed reading, and FIGS. 8 and 9 are explanatory views of operation of the transparent document reading.

Next, according to FIG. 7, with reference to FIG. 6, flat bed reading operation will be explained. The switching mirror 8 is, as shown in FIG. 6, retained at a back reading position by the actuator M2 and the lamp 1 is lit (1200). Carrier units (movable read parts, movable mirrors) 2 and 5 are moved in an A direction of FIG. 6 by the motor 18 until a home position sensor 19 detects them (1210). At this time, carrier units 2, 5 move at a speed half a normal one. Next, the controller 40 moves the carrier units 2, 5 in a B direction, and makes the CCD unit 10 start reading from a constant position (a front end of the document table 70) (1220). Namely, the read image of the document on the document table 70 is projected on CDD via the movable mirror (intermediate mirror) 5, the lens 4, the reflection mirror 7, and the Fresnel lens 6, and the CCD unit 10 reads this projected image via the mirror 8. After the read image is analog-digital-converted by the controller 40, and is stored in the memory 41 for front surface, it is output in conformity to a speed of the host computer (1230).

Next, according to FIG. 9, with reference to FIG. 8, transparent document reading operation will be explained. The switching mirror 8 is, as shown in FIG. 8, retained at a back reading position by the actuator M2 (1300). The lamp 1 is lit, and the carrier units (movable read parts, movable mirrors) 2, 5 are moved in an A direction of FIG. 8 by the motor 18 until the home position of carrier is detected by a sensor 19 (1310). At this time, the carrier units 2, 5 are positioned on a boundary of a white/black target 80 of the document table 70 (1310). Next, the carriers 2, 5 are moved right at a distance of x from the home position of carrier, and are stopped (1320). The valve 9 is rotated at a position of a solid line of FIG. 8 by the actuator M1 (1330). The separation roller 12 is rotated by a motor (not shown), and a sheet (document) 200 is fed from the hopper 40, and after a rear end of the sheet is detected by the sensor A, the sheet is conveyed at a constant distance y (a constant time elapses). Thereafter, before the sheet is ejected from the ejection roller 15, the sheet is stopped conveying, and a rear end of the sheet is gripped (1340). Next, the valve 9 is rotated to a position of a dotted line of FIG. 8 and retained by the actuator M1 (1350). The ejection roller 15 is rotated by a motor (not shown), and the sheet retained by the ejection roller 15 is fed in a reverse direction, and is led to the second conveying route via the valve 9, and when the front end of the sheet reaches a back reading position, the image reading of the CCD unit 10 starts (1360). After the read image is analog-digital-converted by the controller 40, and is stored in a back memory 42, the image of the memory 42 is output in conformity with a speed of the host computer. Since at the time of this reading, a white target of the document table 70 is projected on the screen 3 at a counter side to the document, the transparent document can be read by the CCD unit 10.

In this manner, in the flat bed 20, the movable optical units 2, 5 not having the photoelectric transfer element are provided, and the read image is led from this optical unit to the CCD unit 10 of the ADF 30. Furthermore, so that the images from the carrier units 2, 5 are read by the CCD unit 10, the screen 3 is provided at a read position of the CCD unit 10, and the images on the document table 70 are projected on this screen 3 by the carrier unit 2, 5. Thus, the connection cable of the video signal from the carrier unit 2 to the controller 40 is not required, and it is possible to restrict the occurrence of the EMI which may cause the trouble in other devices.

Furthermore, the screen 3 is provided in the document conveying route of the conveying mechanism, whereby it is possible to share the read position of the photoelectric transfer unit, and the structure is simplified, thereby miniaturizing it.

Furthermore, this embodiment has the hopper 40 for mounting the document to be conveyed to the conveying mechanism, and the switching mirror 8 for switching the read position of the CCD unit 10 between the read position of the conveying mechanism and the screen 3, whereby it is possible to provide the hopper at a position of not interfering with the flat bed, and to realize readily the ADF function.

Furthermore, second conveying mechanisms 16, 17 for conveying the document to be read by the CCD 10 from an exit 15 of the conveying mechanism to a flat bed 70 are provided, and the screen 3 is provided in the document conveying route of the second conveying mechanism, so that it is possible to realize the both-face reading and the flat bed reading by the one CCD unit, and to fairly reduce a device price.

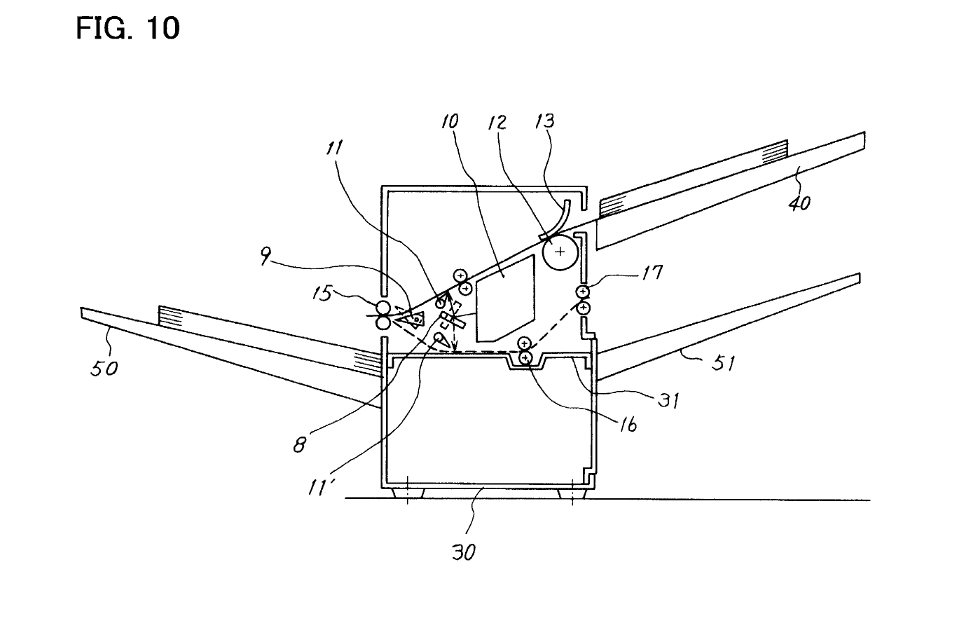

FIG. 10 is an adaptation example of the present invention, and shows a condition that the FB unit 20 of FIG. 1 is detached. In FIG. 10, the same elements shown in FIG. 1 are denoted by the same symbol, and a guide plate 31 and a second stacker 51 are annexed to the ADF unit 30 of FIG. 1. Since the ADF unit 30 and the FB unit 20 have a separable configuration, after the ADF unit 30 like FIG. 10 is purchased, at the point of time when the flat bed reading is necessary, the FB unit 20 of FIG. 1 is purchased, and is attached to the ADF unit 30 of FIG. 10 afterwards, thereby forming the configuration of FIG. 1.

### OTHER EMBODIMENTS

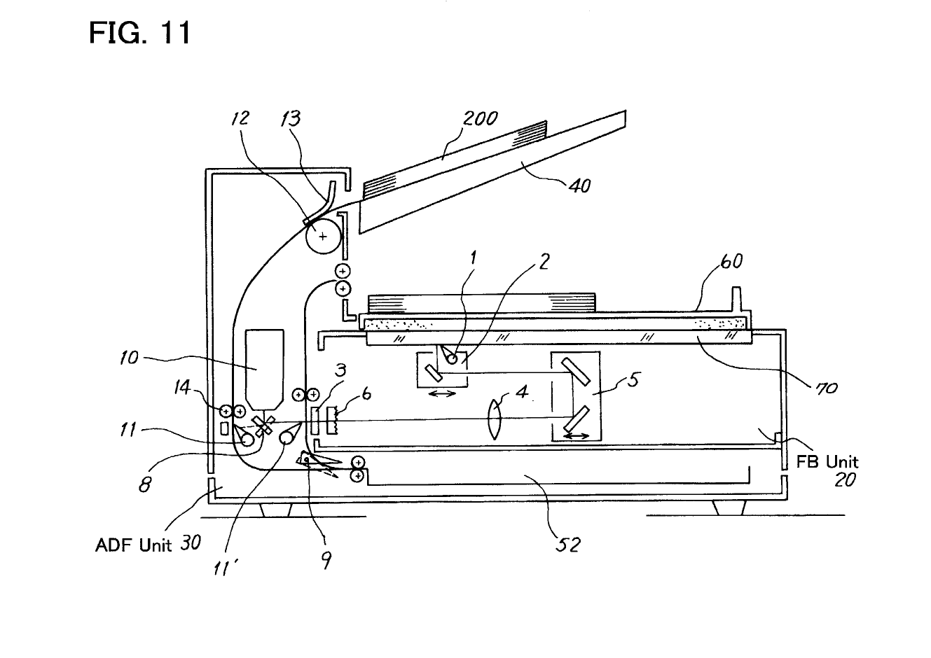

FIG. 11 is a configuration diagram according to another embodiment of the present invention, and a modification example of FIG. 1. In FIG. 11, the same elements shown in FIG. 1 are denoted by the same symbol. In FIG. 11, a tray 52 is provided under the FB unit 20, and a stacker 50 of FIG. 1 is deleted. So, it is possible to provide an ADF/FB reader which can reduce an installation space of the stacker 50 of FIG. 1, and can decrease the installation space.

In addition to the above embodiment, the present invention makes it possible to modify as follows:

(1) The ADF both-face reading was explained, but the present invention can be applied to even the one-face ADF having any one of the surface conveying route and back face conveying route.

(2) The photoelectric transfer element was explained by the CCD, and the other transfer element can be exploited.

Although the present invention has hereinabove been described by way of the embodiments, it would variously been modified without departing from its sprit and those modifications are not to be excluded from the scope of the present invention.

First, the flat bed is provided with a movable optical unit not having a photoelectric transfer element, and reading lights from this optical unit are led to the photoelectric transfer unit of the ADF. Second, in order to read images from the optical unit by the photoelectric transfer unit, a screen is provided at a reading position of the photoelectric transfer unit, and the images of the movable optical unit are projected on this screen. Thus, a connection cable of a read part of the flat head is not required, and it is possible to restrict the EMI which may cause the trouble in other devices.

What is claimed is:

1. An image input apparatus for optically reading a document and inputting images of the document, comprising:
a conveying mechanism for conveying the document in a sub-scanning direction; a photoelectric transfer unit for reading the document to be conveyed;
a flat bed mounting the document;
a screen provided at a reading position of the photoelectric transfer unit; and
a movable optical unit for sub-scanning the document on the flat bed and projecting the images of the document on the screen.

2. The image input apparatus according to claim 1, wherein the screen is provided in a document conveying route of the conveying mechanism.

3. The image input apparatus according to claim 1, further comprising:
a hopper for mounting the document to be conveyed by the conveying mechanism; and
a switching mirror for switching a reading position of the photoelectric transfer unit between the reading position of the conveying mechanism and the screen.

4. The image input apparatus according to claim 3, wherein further comprises a second conveying mechanism for conveying the document to be read by the photoelectric transfer unit from an exit of the conveying mechanism to the flat bed, and wherein said screen is provided in the document conveying route of the second conveying mechanism.

5. An image input apparatus comprising:
an ADF unit provided with a conveying unit and a photoelectric transfer unit; and
a flat bed unit having a flat bed, a screen, and a movable optical unit,
wherein the ADF unit is separable from the flat bed unit.

6. A flat bed unit attached to an ADF unit provided with a conveying mechanism for conveying a document in a sub-scanning direction and a photoelectric transfer unit for reading the document to be conveyed, comprising:
a flat bed mounting the document;
a screen provided at a reading position of the photoelectric transfer unit; and
a movable optical unit for sub-scanning the document on the flat bed and projecting images of the document on the screen.

7. The image input apparatus according to claim 1, wherein the photoelectric transfer unit has a photoelectric transfer element, and an optical system for focusing the image of the reading position on the photoelectric transfer element.

8. The image input apparatus according to claim 1, wherein the movable optical unit has a light source for irradiating the document on the flat bed, and
a reflection mirror for leading the reflected lights from the document to the screen.

9. The image input apparatus according to claim 1, wherein the screen is composed of a semi-transparent screen and a Fresnel lens.

10. The image input apparatus according to claim 4, further comprising a switching valve for switching back the document to the conveying route of the second conveying mechanism at an exit of the conveying mechanism.
